(19) United States
(12) Patent Application Publication
(10) Pub. No.: US 2006/0218075 A1
(43) Pub. Date: Sep. 28, 2006

(54) Exchange traded fund with futures contract based assets

(76) Inventors: Victor D. Feldman, Glencoe, IL (US); Sharon L. Karsten, Chicago, IL (US); Daniel M. Gramza, Evanston, IL (US); William J. P. Dale, Toronto (CA)

Correspondence Address: MAYER, BROWN, ROWE & MAW LLP, P.O. BOX 2828, CHICAGO, IL, 60690-2828, US

(21) Appl. No.: 11/340,233

(22) Filed: Jan. 26, 2006

Related U.S. Application Data
(63) Continuation-in-part of application No. 11/041,121, filed on Jan. 21, 2005.

(51) Int. Cl. G06Q 40/00

(52) U.S. Cl. 705/37

(57) ABSTRACT

An exchange trade fund comprising: an amount of a commodity trading in a spot and futures market, wherein the commodity is deposited with one or more custodians in exchange for one or more creation units as assets of the fund; wherein each creation unit represents a plurality of shares of the fund; and wherein each creation unit is redeemable for an amount of the commodity equal to the net asset value of the creation unit plus interest and less fund expenses and wherein the assets of the fund are invested in futures contracts. Also disclosed is a method for creating an exchange traded fund and a method for facilitating trading of an exchange traded fund.

This application claims priority to and is a continuation-in-part of U.S. patent application Ser. No. 11/041,121, filed Jan. 21, 2005, incorporated herein by reference.

### BACKGROUND OF THE INVENTION

1. Field of the Invention

The present invention relates to a fund. Particularly, the present invention is directed to fund and related methods whereby any financial asset that trades in the both spot and public futures exchange market(s) and/or the off exchange forward marketplace such as currency is converted to equities that can be traded on a secondary market. For example, the financial asset could be currency, which trades in both an Interbank spot market and in the public futures exchange marketplace. It could also extend to other financial assets, such as commodities. Furthermore, it could be directed to pairs and combinations of assets such as groups of two or more currencies or currencies paired with equities or commodities.

2. Description of Related Art

The currency markets represent one of the largest, but least regulated, financial markets. The buying and selling of currency occurs because the value of a particular currency fluctuates with respect to other currencies. Therefore, it is often advantageous to hold money in one form of currency over another. For example, a euro may be worth $1.20 on one day, and may be worth $1.30 the next day. For institutional investors, such as banks, which may hold millions of euros, that fluctuation in price may have a material impact on the overall investment. Investing in foreign currency also provides a means of hedging investments that are dependent on foreign economies.

Prior to the present invention, trading in currencies has been limited to large institutional investors and has not been effectively made available to the masses. Although smaller investors may participate in the currency markets by investing in currency futures, investing in derivatives of any type requires a specialized knowledge. In addition, investors in currency futures typically must open special accounts or complete special documentation as a result of the separate jurisdiction of the Commodities and Futures Trading Commission over futures and the Securities and Exchange Commission over securities. In order to maintain a futures position beyond the expiration of a futures contract, the investor must, at some point in time, sell the near dated contracts and buy the next contract in the sequence laid forth by the exchange. This process is referred to as “rolling” a contract and requires time, skill, attention to liquidity and accurate timing. Currency investment usually takes place on the “interbank” market, wherein a network of banks of dealers operating on a 24 hour basis, spanning across time zones of the major financial centers around the world, effect transactions at negotiated prices. These transactions are typically based on the generally accepted minimum interbank currency transaction of $1 million, with the average currency transaction being $10 million. The significant size of these transactions precludes most of the investing public and smaller firms from participating in this market and obtaining the favorable prices available at that level of investment. As a result, the bid and offer spread for the investing public and smaller firms' transactions will often be wider than the spread between the bid and offer available to institutions. This means that the investing public and smaller firms will pay more when they are buying a currency and receive less when they are selling a currency compared to institutions dealing in the interbank market.

Another aspect of the currency markets prior to the present invention is the lack of standardized pricing. Interbank currency contracts are not standardized and transactions are not reportable, nor do prices quoted by banks and dealers necessarily reflect the price at which they are willing to effect particular transactions. Thus, there is no way for all parties interested in purchasing and selling currencies to transact at prices which are fully transparent to all participants. A centralization of order flow and transparency of prices should contribute to narrowing spreads between bid and ask prices for currencies.

In addition, the individual or smaller investor typically does not have access to the futures markets for the purposes of trading currency and other commodities. First, futures markets require that the trader have an account with a clearing firm to clear trades on the futures markets. Second, use of a futures markets requires constant attention to the timing and nature of contracts being traded so that the investor can time delivery of an underlying asset or continue to “roll” the contract over, or to trade out of the contract and settle financially.

A popular way for the investing public to have access to a broad range of investments is through an investment company. Investment companies generally are of two varieties: a unit investment trust (“UIT”) or management investment company. A UIT invests in a specified portfolio of securities. There is no investment manager. A sponsor and a bank trustee oversee the administration of the UIT. A UIT continuously creates and redeems its shares at net asset value per share (“NAV”). A management investment company may be organized as an open end or closed end fund. In closed ended funds, assets are raised at the outset for the purchase by the fund manager, typically a trust, of underlying securities. Investors often pay a premium at the initial fund seeding in the hopes that the fund will eventually trade at a premium relative to the value of the underlying securities. In a closed end fund, shares of the fund are created at the fund's inception and cannot be redeemed for the underlying securities. Accordingly, there is often a disconnect between the value of the fund shares and the NAV of the fund. This disconnect may be a positive, in that the fund shares may trade at well above the NAV, but may also be a negative if closed end funds do not achieve their promise and end up trading below the fund's NAV.

Open ended funds, on the other hand, as in the case of a UIT, continuously issue and redeem shares at NAV. Exchange traded funds maybe organized as UITs or as open end funds. Exchange traded funds continuously offer and redeem their shares in creation units at NAV. Creation units represent a fixed amount of shares of the fund, which can be redeemed at any time for the underlying securities of the fund. Because fund shares may be created and redeemed throughout the life of the fund, the fund shares typically trade at or near the NAV of the fund. Deviations in the price of the fund shares relative to the NAV will contribute to increased creation and redemption activity, which tends to decrease the arbitrage between the NAV and the price of the fund shares.

Exchange traded funds, therefore, have advantages in that they provide liquidity without negatively affecting the value of the shares of the fund on the secondary market. In addition, an exchange traded fund provides truer exposure to the value of the underlying securities, often making it a preferable investment tool for the investing public interested in benefiting from the performance of the securities the fund was intended to track.

For an open ended fund to achieve its objectives, there must be a transparent means of calculating the NAV of the fund. For funds such as exchange traded funds, which track a collection of securities that themselves trade on the secondary market, the NAV is evident because there is a transparent market for each of the underlying securities. The problem of adapting an exchange traded fund to the currency or commodities markets is immediately evident. Because, as related above, currencies and any commodities trade in the over the counter market in largely unreported transactions of different types, a standardized method for calculating the NAV of a holding of currencies or commodities has not been established.

Exchange traded funds which convert currency holdings to shares tradeable on the secondary market have not been developed for an additional reason. The currency underlying the fund must be held by a custodian, which will typically be a bank. Those holdings will inevitably earn interest. The accrual of interest, while generally a positive in an investment, upsets the balance between the value of the share of the fund and the value of the underlying currency. Thus, an investor wishing to redeem one or more creation units might receive not only the underlying currency, but the interest accrued. This feature would make the value of the creation unit dependent upon when the creation unit is redeemed. In short, a system is needed wherein the interest on the currency holding can be accounted for and allow shares of the fund to remain fungible on the secondary market. Prior to the present invention, no system had been devised which would account for interest accruals in calculating the NAV of the fund.

### SUMMARY OF THE INVENTION

The purpose and advantages of the present invention will be set forth in and apparent from the description that follows, as well as will be learned by practice of the invention. Additional advantages of the invention will be realized and attained by the methods and systems particularly pointed out in the written description and claims hereof, as well as from the appended drawings.

To overcome the disadvantages of the prior art, a perpetual futures contract fund is provided which could invest in any asset that trades in both a spot and futures or forward contract marketplace. An example would be a currency exchange traded fund as currency trades in such marketplaces. According to embodiments of the present invention, any financial asset that trades in the both spot and public futures exchange market(s) and/or forward marketplace such as currency or other commodities are equitized for trading on the secondary market. In addition, a method for calculating the NAV of the fund's holdings is provided. Finally, a process is provided which ensures that the NAV of the fund is periodically reset to account for interest accruals on the underlying investment. In addition to calculating the NAV, the present invention also contemplates using the disclosed methods herein to calculate an Intraday Indicative Value (“IIV”). NAVs are typically calculated at a particular closing time, while IIVs are calculated throughout the day.

In brief, a first embodiment of the invention is an exchange traded fund comprising: an amount of a commodity, wherein the commodity is deposited with one or more custodians in exchange for one or more creation units as assets of the fund; wherein each creation unit represents a plurality of shares of the fund; and wherein each creation unit is redeemable for an amount of the commidity equal to the net asset value of the creation unit; and wherein the assets of the fund are invested in futures contracts. According to further advantageous embodiments, the net asset value of each share of the fund is based on a combination of prices of currency from a plurality of sources, such as banks or derivative prices for the currency. Further embodiments provide that the currency is held by the one or more custodians in a bank instrument and/or, money market investments and may enter into futures of forward contracts for the benefit of the investor for the purpose or replicating the change of value of the underlying asset(s) which the ETF represents, and further wherein currency is purchased for the value of the currency plus a cash component. The cash component represents interest that would have accrued on the investment if the creation unit had been created earlier, and a dividend is paid out to investors in an amount based on the interest accrued plus the cash component. Thus, the NAV is reset periodically to match the value of the currency without regard to interest accrued on the investment. The investment company may be organized as an exchange traded fund or a closed end fund.

Another aspect of the present invention, susceptible to the embodiments described above, is a method for converting any financial asset that trades in the both spot and public futures exchange market(s) and/or forward marketplace such as currency, to shares of an investment company tradeable on a secondary market comprising: establishing a trust; accumulating assets to the trust for the purchase of money market instruments, bank instruments or other cash equivalent assets and entering into derivative contracts such that the change in price of the derivative contact represents the same or a multiple of the change of the underlying assets being represented by the objective of the investment management company; depositing the assets and contracts with one or more custodians; creating creation units comprising a plurality of shares, wherein the creation units are redeemable for an amount equal to the net account balance at the time of redemption based on the net asset value of the creation unit; and issuing the creation units to investors.

Yet a further embodiment of the invention, subject to the features described above, is a method for facilitating the trading of an exchange traded fund comprising: providing an exchange comprising a secondary market for shares of the fund and wherein the fund comprises: an amount of investment capital comprising of cash, currency, financial assets such as money market securities and futures/forward contracts (investment account assets), wherein the investment account assets is deposited with one or more custodians in exchange for one or more creation units; wherein each creation unit represents a plurality of shares of the investment company; and wherein each creation unit is redeemable for an amount of the investment account assets equal to the net asset value of the creation unit plus interest and less investment company expenses. The investment company may be organized as an exchange traded fund or a closed end fund.

Yet a further embodiment is a closed end fund comprising: investment account assets; and the distribution of shares of the fund to one or more investors, wherein the shares of the fund have a net asset value based on a combination of prices of the investment account assets from a plurality of sources or the public exchanges on which futures contracts trade, and wherein interest earned on the short-term bank instruments less futures cost-of-carry (or basis) are paid out to the one or more investors as a dividend.

It is to be understood that both the foregoing general description and the following detailed description are exemplary and are intended to provide further explanation of the invention claimed.

The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF THE DRAWINGS

FIG. 1 is a flow chart of certain activity relating to the creation unit creation process according to an embodiment of the present invention.

FIG. 2 is a flow chart of certain activity relating to the creation unit creation process according to an embodiment of the present invention.

FIG. 3 is a flow chart of certain activity relating to the creation unit creation process according to an embodiment of the present invention.

FIG. 4 is a flow chart of certain activity relating to the creation unit redemption process according to an embodiment of the present invention.

FIG. 5 is a flow chart of certain activity relating to the creation unit redemption process according to an embodiment of the present invention.

FIG. 6 is a flow chart of certain activity relating to the creation unit redemption process according to an embodiment of the present invention.

FIG. 7 is a flow chart of certain activity relating to the creation unit redemption process according to an embodiment of the present invention.

FIG. 8 is an example of the NAV interest accumulation mechanism according to an embodiment of the present invention.

FIG. 9 is the decision process for selecting custodian banks according to an embodiment of the invention.

FIG. 10 is the process for investing funds received during the creation unit creation process and reflects the ongoing management of the assets according to an embodiment of the invention.

### DETAILED DESCRIPTION OF THE PREFERRED EMBODIMENT

Reference will now be made in detail to the present preferred embodiments of the invention, an example of which is illustrated in the accompanying drawing. The method and corresponding steps of the invention will be described in conjunction with the detailed description of the system.

According to a first preferred embodiment of the present invention, the investment company is embodied in an open ended fund, preferably an exchange traded fund. According to a further preferred embodiment, the exchange traded fund is a UIT. However, one skilled in the art will readily see from the description that follows that the fund can be quite easily adapted to a management investment company by substituting the role of the Trustee for the fund Manager. In addition, the activities of the various Trustee departments may be performed by other qualified entities in the management investment company example.

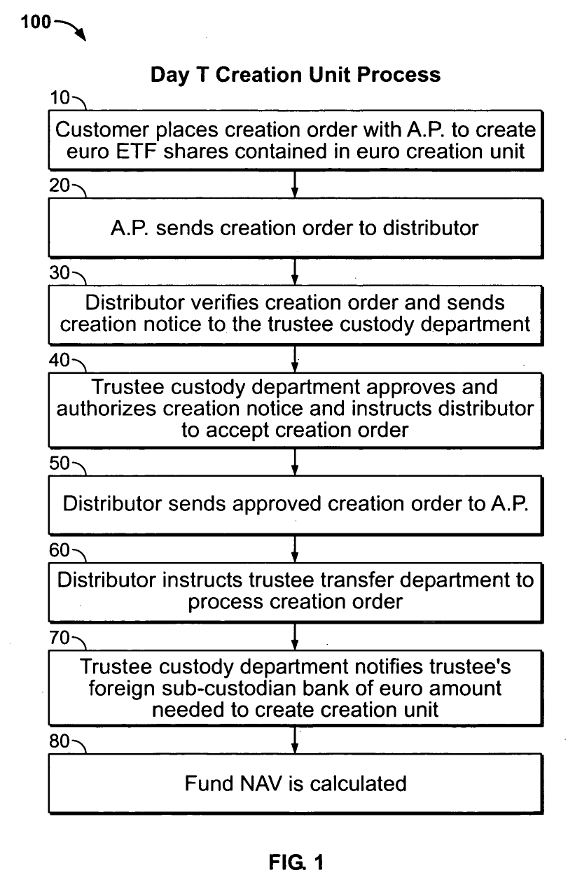

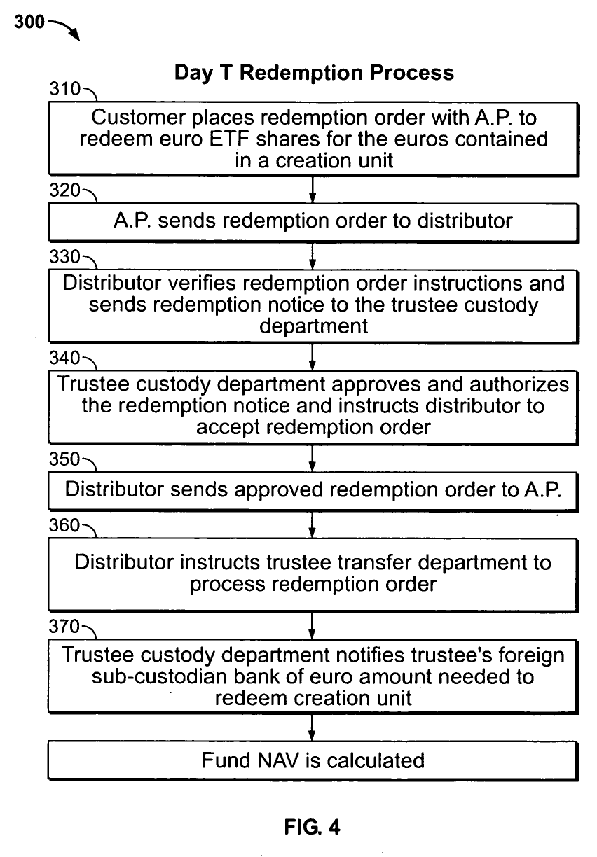

The creation and redemption process is an integral piece of the exchange traded fund embodiment's operation. FIGS. 1-3 depict the creation process according to a preferred embodiment of the invention. FIGS. 4-7 depict the redemption process according to a preferred embodiment of the invention. Although the figures depict the process specific to the euro, it should be understood that the invention relates to any any financial asset that trades in the both spot and public futures exchange market(s) and/or the off exchange forward marketplace. In addition, the present invention may be applied to a basket of financial assets that trades in the both spot and public futures exchange market(s) and/or the off exchange forward marketplace selected at the discretion of the investment company. For example, embodiments of the present invention may relate to creating an equity based on Asian currencies, which might include for example, the yen, the yuan, the Hong Kong dollar, the won and/or the rupee. In one example, a known index of currencies might be selected which comprises a particular weighting of the desired currencies, and baskets of those currencies and/or futures or forward contact(s) representing the underlying currencies can be bought according to the appropriate weighting to create an equity that tracks the index.

According to the preferred embodiment of an open ended fund herein described, there are various parties which participate in the process. These parties generally include a clearing firm; in the case of a UIT, a trustee; in the case of a management investment company, a sponsor or manager; an Authorized Participant, usually an institutional investor, specialist or market maker who has signed a participant agreement with a particular fund sponsor or distributor; the Distributor; and the Customer. The skilled artisan will recognize that the above participants are the typical intermediaries in the investment world according to common legal structures and pertinent federal regulations, but that other structures and participants may also be involved without departing from the scope of the invention.

The creation of the creation unit will depend on the status of the fund one business day before the creation unit is ordered. This is necessary to account for the cash component that will have to be invested to compensate for accrued interest. Assuming the creation unit is ordered on Day T, the first step, on T minus one business day, is for the clearing firm to send the portfolio composition file created that day by the fund's Trustee to the Authorized Participant. The portfolio composition file will consist of a fixed amount of assets (i.e., euros and/or U.S. money market securities and Euro foreign exchange futures contracts in an amount that represents the underlying U.S. assets in the fund) and a cash component less expenses representing the net income per share less futures cost-of-carry (or basis) accrued (since the last dividend payment date) as of T−1 business day. In order to calculate the daily cost of carry, the Trustee will need to track this amount in conjunction with tracking of the daily accrual of interest in the account according to a preset formula consistent with the nature of the cost-of-carry for each asset represented in each separate fund.

The following description uses the example of a euro currency fund notwithstanding the fact that the invention can be used for a multiple of assets as described previously in this document. FIG. 1 depicts the activity on Day T. At 10, The Customer places a Creation Unit Order with the Authorized Participant to create the euro ETF shares which are contained in the euro Creation Unit. At 20, the Authorized Participant send the Creation Unit Order to the Distributor. It should be understood that multiple Authorized Participants may have their orders combined to create a single (or multiple) Creation Units. Preferably, security measures will be taken, such as including a personal identification number (PIN) and the signature of the signatory assigned to the PIN. At 30, the Distributor reviews the Creation Unit Order instructions, verifies the PIN and signature, and sends the Creation Notice to the Trustee Custody Department for approval. At 40, the Trustee Custody Department reviews and approves the Creation Notice, assigns an authorization number to the Creation Notice, and instructs the Distributor to accept the Creation Unit Order. At 50, the Distributor sends the approved Creation Unit Order with an authorization number to the Authorized Participant. At 60, the Distributor informs the Trustee Transfer Department of the Creation Unit Order, authorization number and Authorized Participant information and instructs them to process the Creation Unit Order. At 70, the Trustee Custody Department notifies the Trustee's Foreign Sub-Custodian Bank of the euro amount needed to create a euro Creation Unit and the Authorized Participant's foreign custodian details. At 80, the fund's NAV is calculated, and the NAV is used to calculate the amount due. The present system may also be applied to embodiments wherein the Transfer Department and/or Custody Department are actually separate entities (as in the case of the management investment company, in which there is no Trustee but instead a Manager or Sponsor).

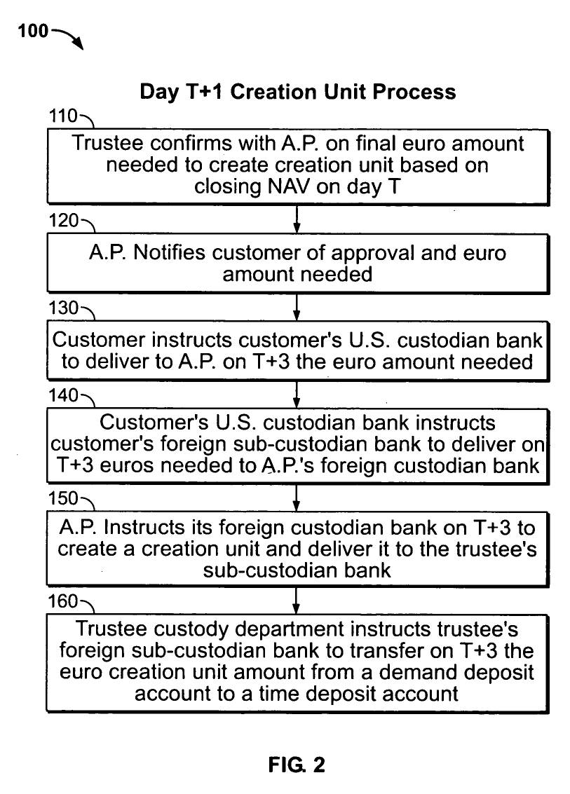

FIG. 2 depicts the activity on Day T plus one business day (Day T+1). At 110, the Trustee confirms with the Authorized Participant the final amount needed to create a euro Creation Unit, based upon on the closing NAV of the ETF Fund on Day T. At 120, the Authorized Participant notifies the Customer of the approval of the Creation Order and the euro amount needed to create a Creation Unit. At 130, upon the approval of the Creation Order, the Customer instructs his U.S. Custodian Bank to deliver to the Authorized Participant on Day T+3 (Day T plus three business days) the amount needed to create a Creation Unit. It should be noted that the euro amount may be presented in euros, but it also may be provided in any euro equivalent, such as other currency. At 140, the Customer's U.S. Custodian bank instructs the Customer's Foreign Sub-Custodian Bank to deliver on Day T+3 the amount needed to create a Creation Unit to the Authorized Participant's Foreign Custodian Bank. At 150, the Authorized Participant sends instructions to Authorized Participant's Foreign Custodian Bank on Day T+3 containing the amount needed to create a Creation Unit and to deliver to the Trustee's Sub-Custodian Bank the Creation Unit amount. At 160, the Trustee Custody department sends instructions to the Trustee's Foreign Sub-Custodian Bank to transfer on Day T+3 the final Creation Unit amount from a Demand Deposit account to an investment account(s). This final step usually applies due to policies of foreign custodial banks which typically receive currency in demand deposits. Thus, to take advantage of interest, the Trustee (or Manager/Sponsor in the case of a management investment company) may want the currency transferred to an interest-bearing time deposit account. As an alternative, the currency may be held in any other short term interest earning way, including for example, futures contracts.

On Day T+2, the Authorized Participant's Foreign Custodian Bank and the Trustee Foreign Sub-Custodian Bank confirm matching instructions for the Creation Unit amount to be delivered. The Trustee and Authorized Participant resolve any differences.

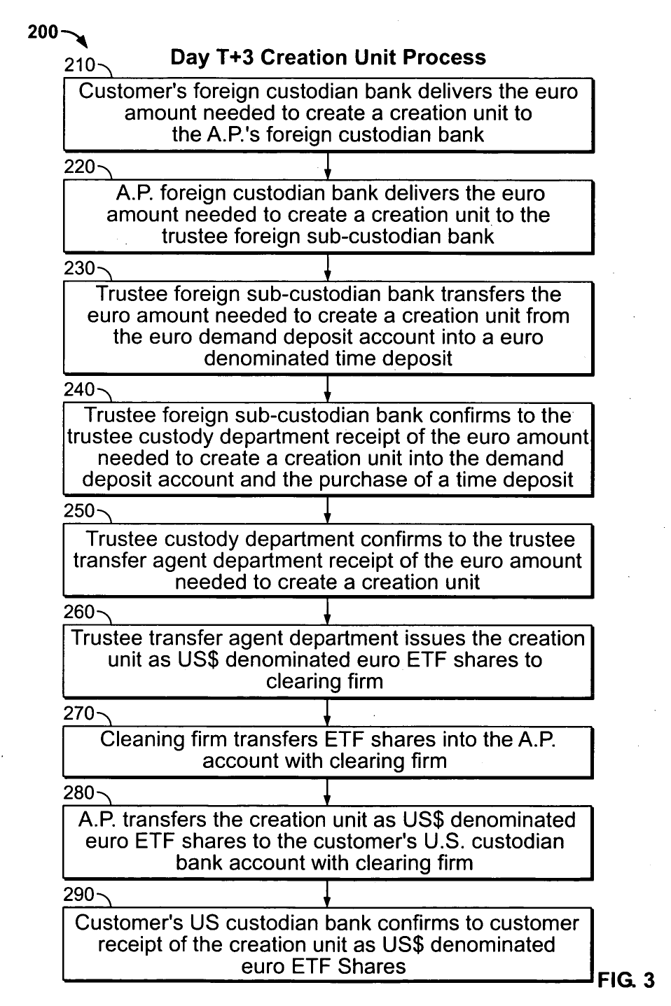

FIG. 3 depicts the activity on Day T+3 which leads to the ultimate U.S. dollar-denominated euro Creation Unit. At 210, the Customer's Foreign Custodian bank delivers the euro amount needed to create a Creation Unit to the Authorized Participant's Foreign Custodian Bank. At 220, the Authorized Participant's Foreign Custodian bank delivers the amount needed to create a Creation Unit to the Trustee Foreign Sub-Custodian Bank. At 230, the Trustee Foreign Sub-Custodian Bank transfers the amount needed to create a Creation Unit from the Demand Deposit account into a denominated Time Deposit or similar interest bearing account. At 240, the Trustee Foreign Sub-Custodian Bank confirms to the Trustee Custody Department receipt of the amount needed to create a Creation Unit into the Demand Deposit account and the purchase of a Time Deposit or similar interest bearing account. At 250, the Trustee Custody Department confirms to the Trustee Transfer Agent Department receipt of the amount needed to create a Creation Unit. At 260, the Trustee Transfer Agent Department “marks-up” the ETF Global Depository Certificate with shares and issues the Creation Unit as U.S. dollar-denominated euro ETF shares to a clearing firm for the Authorized Participant's account. This step is preferably accomplished through an automated Deposit/Withdrawal at Custodian (DWAC) system. At 270, the clearing firm transfers free (that is, without reference to the “delivery versus payment” process) from the Trustee Transfer Agent's participant account, the Creation Unit as U.S. dollar-denominated euro ETF shares into the Authorized Participant's account at the clearing firm. At 280, the Authorized Participant transfers free the Creation Unit as U.S. dollar-denominated euro ETF shares to the Customer's U.S. Custodian Bank's account at the clearing firm. At 290, the Customer's U.S. Custodian Bank confirms to the Customer receipt of the Creation Unit as U.S. dollar-denominated euro ETF shares.

The creation unit redemption process is similar in many respects to the creation process. For example, on Day T−1 (with Day T representing the date on which the redemption order is placed), a clearing firm sends the portfolio composition file created that day by the fund's Trustee to the Authorized Participant. The portfolio composition file will consist of a fixed amount of currency (i.e., euros and/or U.S. money market securities and Euro foreign exchange futures contracts in an amount that represents the underlying U.S. assets in the fund) and a cash component less expenses representing the net income per share less futures cost-of-carry (or basis) accrued (since the last dividend payment date) as of T−1 business day. In order to calculate the daily cost of carry, the trustee will need to track this amount in conjunction with tracking of the daily accrual of interest in the account according to a preset formula consistent with the nature of the cost-of-carry for each asset represented in each separate fund. Furthermore, Day T in the redemption process follows the same steps as Day T in the creation process, except that the process takes place with respect to a Redemption Order rather than a Creation Order. The Day T process is depicted in FIG. 4.

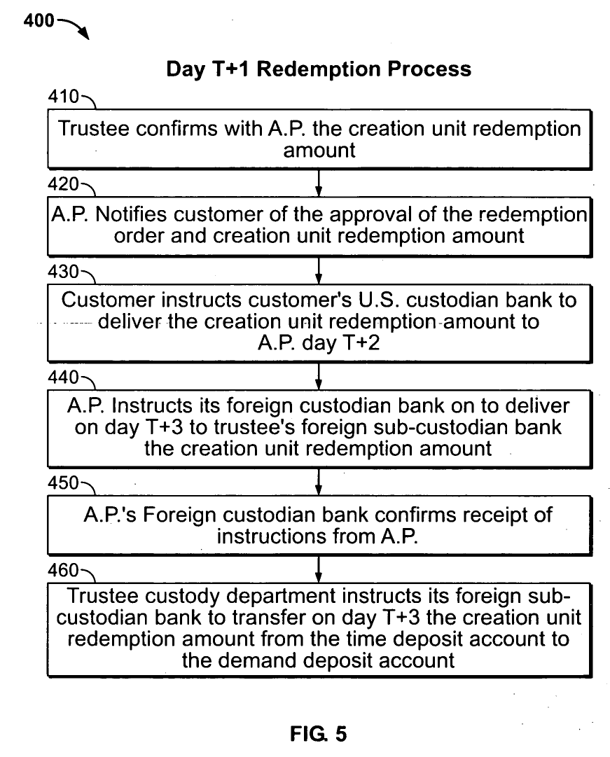

FIG. 5 depicts the redemption process at Day T+1. At 410, the Trustee confirms with the Authorized Participant Creation Unit redemption amount. At 420, the Authorized Participant notifies the Customer of the approval of the Redemption Order and the Creation Unit redemption amount. At 430, upon the approval of the Redemption Order, the Customer instructs the Customer's U.S. Custodian Bank to deliver free the Creation Unit redemption amount to the Authorized Participant on Day T+2. At 440, the Authorized Participant sends instructions to the Authorized Participant's Foreign Custodian Bank to deliver, on Day T+3, to the Trustee's Foreign Sub-Custodian Bank, the Creation Unit redemption amount. At 450, the Authorized Participant's Foreign Custodian Bank confirms receipt of instructions from the Authorized Participant. At 460, the Trustee Custody Department sends instructions to the Trustee's Foreign Sub-Custodian Bank to transfer on Day T+3 the Creation Unit redemption amount from the Time Deposit account to the Demand Deposit account.

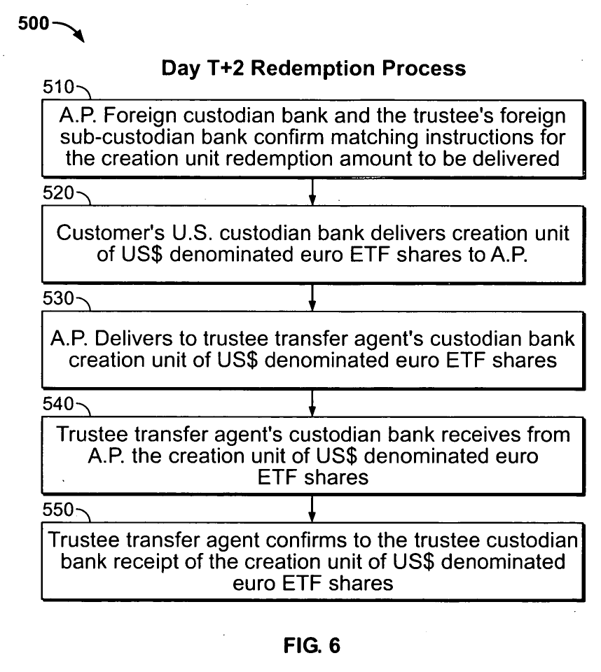

FIG. 6 depicts the redemption process at Day T+2. At 510, Authorized Participant's Foreign Custodian Bank and the Trustee's Foreign Sub-Custodian Bank confirm matching instructions for the Creation Unit redemption amount to be delivered. Any information differences are referred back to the Trustee and the Authorized Participant. At 520, the Customer's U.S. Custodian Bank delivers free through the automated Deposit/Withdrawal at the Trustee Custodian system the Creation Unit of U.S. dollar-denominated euro ETF Shares to the Authorized Participant. At 530, the Authorized Participant delivers free through the automated Deposit/Withdrawal at Trustee Custodian system to the Trustee Transfer Agent's Custodian Bank the Creation Unit of U.S. dollar-denominated euro ETF Shares. At 540, the Trustee Transfer Agent's Custodian Bank receives from the Authorized Participant Creation Unit of U.S. dollar-denominated euro ETF Shares, preferably through the DWAC system. At 550, the Trustee Transfer Agent confirms to the Trustee Custodian Bank receipt of the Creation Unit of U.S. dollar-denominated euro ETF Shares.

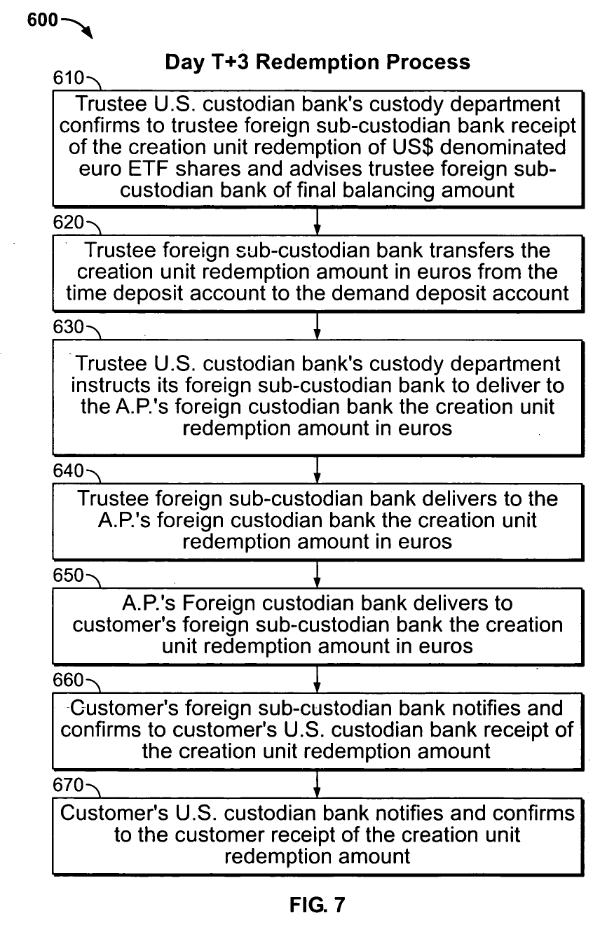

Finally, FIG. 7 depicts the redemption process at Day T+3, culminating in the receipt of monies for the Creation Unit. At 610, the Trustee U.S. Custodian Bank's Custody Department confirms to the Trustee Foreign Sub-Custodian Bank receipt of the Creation Unit redemption of U.S. dollar-denominated euro ETF Shares and advises the Trustee Foreign Sub-Custodian Bank of the final balancing amount. At 620, the Trustee Foreign Sub-Custodian Bank transfers the Creation Unit redemption amount from the investment account to the Demand Deposit. These funds represented the underlying investment securities. At 630, the Trustee U.S. Custodian Bank's Custody Department instructs the Trustee Foreign Sub-Custodian Bank to deliver to the Authorized Participant's Foreign Custodian Bank the Creation Unit redemption amount. At 640, the Trustee Foreign Sub-Custodian Bank delivers to the Authorized Participant's Foreign Custodian Bank the Creation Unit redemption amount. At 650, the Authorized Participant's Foreign Custodian Bank delivers to the Customer's Foreign Sub-Custodian Bank the Creation Unit redemption amount. At 660, the Customer's Foreign Sub-Custodian Bank notifies and confirms to the Customer's U.S. Custodian Bank receipt of the Creation Unit redemption amount. At 670, the Customer's U.S. Custodian Bank notifies and confirms to the Customer receipt of the Creation Unit redemption amount.

An aspect of the present invention is the use of demand and time deposits or investment accounts to represent the underlying asset(s). In accordance with a preferred embodiment, a combination of money market securities, cash equivalent bank instruments, short dates interest bearing securities, futures and/or forward contracts are used.

In accordance with a further preferred aspect of the invention, certificates having a constant interest rate and a floating principal could be used. This feature allows continuous creation and redemption by continuously adding to the time deposit throughout the relevant period. The interest on the principal can be easily calculated so that the cash component can be figured. The interest can then be paid out as a dividend when the time deposit matures so that close association between the NAV and underlying value of the currency is maintained.

A potential system could operate as follows. Creation Units (preferably 400,000 shares of stock which give the holder the right to redeem those 400,000 shares for 10 million euros) are created throughout the month by deposit into a bank of 10 million euros, with the bank holding the euro in a fixed interest rate, floating principal certificate. Although the preferred embodiment provides for a Creation Unit of 400,000 shares of 10 million euros (so that, except from accrued interest and expenses, the shares will trade at an NAV of 25.00 euros), it should be apparent that alternative sizes of Creation Units may be used depending upon the desired euro NAV of the investment company. According to the preferred embodiment, therefore, additional Creation Units may be created throughout the month by adding increments of 10 million euros (plus interest, as described below) to the principal of the bank instrument. Every day, the principal being held in all of the appropriate banks earns interest, with each bank offering a fixed rate. The fixed rates from bank to bank will be amalgamated to produce a blended average single interest rate for all Creation Units. In order to create a Creation Unit on a subsequent day, the “principal” 10 million euros is deposited, plus an additional amount equal to the accrued interest up to that point for the month. At the end of the month, or whenever the bank instrument is set to pay out, the interest income (less fund expenses) is distributed as a dividend to whomever owns shares. The requirement that later-created Creation Units include accrued interest upon creation ensures that each holder of a share at the payout date is paid all of the interest income due to that share and ensures that every share is treated the same on the payout date. Thus, the NAV (in euros), which began at 25 euros/share and increased as interest accrued, gets reset to 25 euros/share for the next month's cycle. (The NAV of the shares in dollars will fluctuate based on the exchange rate for the euro). This feature allows each Creation Unit, and thus the shares derived there from, to remain fungible. In addition, because the principal in the bank instrument is allowed to float, Creation Units may be redeemed continuously throughout the month for 10 million euros (per 400,000 shares) plus the accrued interest (less expenses).

Yet another aspect of the invention is the monthly distribution of interest income paid out in monthly dividend amounts. This feature allows for the fund to reset its value back in line with the associated currency. For example, if the fund consists of 10 million euros, and the euros had a net income of $0.015 (US) interest per euro on the time deposits (or other applicable bank instrument used to hold the currency), and the value of the euro to the dollar is $1.15 (US), the fund would be valued at $11.65 million (US) (or $1.165 (US) per euro). Upon the predetermined date, the accrued income would be removed from the fund and the value of the fund would reset to $11.5 million (US)—the then-current spot value of 10 million euros.

The frequency of the income distribution can occur on a fixed monthly date, e.g., the 25^{th} of the month. Alternatively, the date of distribution could be the expiration date of the underlying foreign currency futures contract, with payment to follow, for example, three business days later.

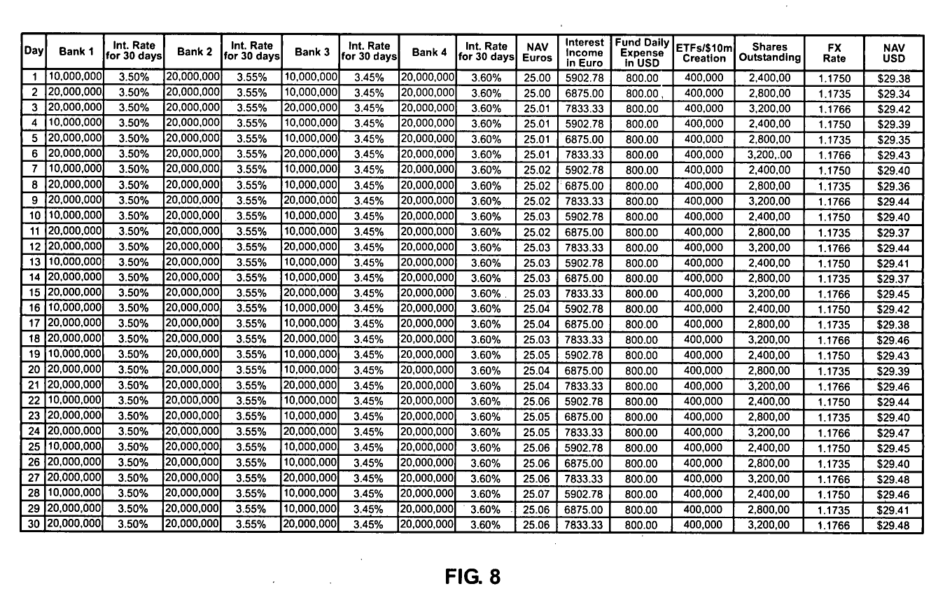

FIG. 8 depicts a spreadsheet showing the effects of the above process. In this simplified model, four banks are used for holding the thirty day, fixed interest, floating principal time deposits. Bank 1 has an interest rate of 3.50%, Bank 2 has a rate of 3.55%, Bank 3 has a rate of 3.45%, and Bank 4 has a rate of 3.60%. The use of multiple banks, and the advantages thereof, is explained in greater detail below. Further, according to this example, euros are deposited in each of the banks every day throughout the period in units of 10 million or 20 million euros. Assume that each 10 million euro deposit entitles one to 400,000 shares of the ETF (i.e., 10 million euros is the initial value of one creation unit). Assume the daily fund expenses are $800, and assume a fluctuating foreign exchange rate of dollars to euro as set forth in the chart. The calculation of the exchange rate will be described in greater detail below.

Initially, the NAV of the ETF in euros is 25.00 (the total euros held, plus interest accrued (in euros), less fund expenses (in euros)). On day 15, due to interest accrued on the time deposits, the NAV of the ETF in euros is 25.03. On day 30, it is 25.06. In order to buy a creation unit on day 15, therefore, a cash component of 0.03 euros per share must be added to the purchase price to account for interest that would have been earned. Following maturity of the certificates after day 30, a dividend of 0.06 euros per share is paid out to holders of the shares. Thus, the NAV is reset to 25.00 for the next time deposit cycle.

Another aspect of the present invention is the calculation of the currency exchange rate. Because exchange rates differ from bank to bank and are not transparent to investors, a standardized method of establishing a competitive and useful exchange rate is necessary. In accordance with a preferred embodiment of the present invention, the exchange rate is calculated as herein described. Although examples are set forth for euros, it should be understood that any currency may be used.

The preferred algorithm for the calculation of the IIV and NAV will be based on a blend of a weighted average of the bid/offer midpoint of a selected number of the most active contributor banks to the interbank cash foreign exchange market and the most active front month futures contract rate.

In practice, and according to the preferred embodiment, the fix of the currency fund IIV/NAV pricing will occur Monday through Friday at 4:00 PM EST, although any time for fixing the NAV may be set by the investment company. The currency fund pricing should be available during the market hours of the twenty-four hour cash foreign exchange market.

The pricing formula is as set forth in the below equation:
IIV=NAV=X₀(Y₀)+X₁(Y₁)+X₂(Y₂)+X₃(Y₃)+X₄(Y₄)+FI−FE
where

IIV=Price of Currency fund generated throughout the trading session.

NAV=Price of Currency fund generated at the end of trading session.

Xₒ=calculation of the spot price from the futures price=X_{f}/{[1+(r_{fo}×t/365)]/[1+(r_{do}×t/365)]}

X_{f}=most active front month futures contract price

r_{fo}=current foreign short term 30 day (LIBOR) interest rate

r_{do}=current domestic short term 30 day interest rate

t=number of days between futures trading date and futures expiry date

X_{1 . . .} =current individual bank spot exchange rate

Y_{0 . . .} =Weighting factor

FI=Fund Interest Income on a daily basis

FE=Fund Expenses on a daily basis

An example of the IIV/NAV calculation is set forth below.

### EXAMPLE 1

This example will calculate the spot price from the futures price on Jan. 5, 2004 using the March contract (expiry date Mar. 16, 2004). The following information is applicable:

X_{f}=most active front month futures contract price=1.2173

r_{fo}=foreign short term 30 day (LIBOR) interest rates=2.00%

r_{do}=domestic short term 30 day interest rates=1.50%

Futures trading date=May 1, 2004

Futures expiry date=Mar. 16, 2004

t=number of days between futures trading date and futures expiry date=70

Thus the spot exchange rate from the futures price will be:

$$\begin{matrix}{X}_{o} = {X}_{f} / \{ [ 1 + ( {r}_{fo} ⨯ t / 365 ) ] / [ 1 + ( {r}_{do} ⨯ t / 365 ) ] \} \\ = 1.2173 / [ 1 + ( 0.02 ⨯ 70 / 365 ) ] / [ 1 + ( 0.015 ⨯ 70 / 365 ) ] \\ = 1.2173 / [ 1.0057 / 1.0029 ] \\ = 1.2173 / [ 1.0028 ] \\ = 1.2138\end{matrix}$$

X_{1 . . .} =current selected individual bank spot exchange rate quotes

| | Bid | Ask | Midpoint |
|---|---|---|---|
| X₁ = | 1.2135 | 1.2139 | 1.2137 |
| X₂ = | 1.2137 | 1.2141 | 1.2139 |

| | |
|---|---|
| Y_{0 . . .} = | Weighting factors. |

The weighting factors will preferably be evaluated on a quarterly basis. The futures weighting will be based on the daily dollar value percentage of currency futures to the total dollar value cash market of the individual currency. The balance of the weighting will be determined by an amalgamation of 2 to 100 identified cash banks quotes.

Example of Weighting Factor Calculation:

Euro futures contract size=125,000 Euros

Euro futures front month (June) contract average price for May 2004=1.20

Euro futures June contract average US$ value for May 2004=125,000*(1.20)=$150,000 (US)

Euro futures June contract volume for 20 trading days in May=1,328,943 contracts

Euro futures total dollar value for May=$150,000 (US)*(1,328,943)=$199,341,450,000 (US)

Euro futures June Average daily dollar value=$199,341,450,000 (US)/20 Days=$9,967,072,500 per day (US)

Foreign exchange cash market estimated daily value=$1.7 trillion (US) (Based on industry standard estimate and noted by U.S. Federal Reserve banks).

Euro cash is estimated to be 30% of the $1.7 trillion (US) foreign exchange market daily value=0.30*($1.7 trillion (US))=$510 billion (US)

Weighting Factor for (Euro) Futures Calculation=Euro cash daily value/Foreign currency cash daily value=$9,967,072,500 (US) per day/$510 billion (US)=0.02

Thus,

Y₀=0.02=Weighting Factor for Futures to Spot

Y₁=0.49=Weighting Factor for Bank 1 Spot Quote

Y₂=0.49=Weighting Factor for Bank 2 Spot Quote

FI=Fund Interest Income On A Daily Basis=Interest Earned On Money Market Euros Deposits.

Assume interest=1.25%/year

Interest Income=1.25%/365 days=$0.00003425 (US) interest income/day

FE=Fund Expenses on a daily basis=25 basis points/year

At 25 basis points/365 days=$0.0000685 (US) expenses/day

Therefore,
Intraday Pricing=NAV=X₀(Y₀)+X₁(Y₁)+X₂(Y₂)+X₃(Y₃)+X₄(Y₄)+FI−FE

$$\begin{matrix}Intraday Pricing = Nav \\ = 1.2138 ( .02 ) + 1.2137 ( .49 ) + 1.2139 ( .49 ) + \\ .00003425 - .0000685 \\ = .0243 + .5947 + .5948 + .00003425 - .0000685 \\ = \$1 .2139 ( US )\end{matrix}$$

The next step is to calculate the share price.

Assuming a 10 million euro creation unit.

10 million euro*$1.2139 (US)/euro=$12,139,000 (US)

$12,139,000 (US) needed to covert 10 million euros

$12,139,000 (US)/400,000 shares=$30.35 (US)/share

As indicated above, the present invention may also be used to equitize a basket of currencies instead of a single currency. In this embodiment, different categories of currency indices which track different international economic barometers of a specific currency or a basket of currencies may be utilized. These categories include, without limitation: a Base Reference Currency index such as a U.S. Dollar Index (which represents a value for a currency based on a basket of specified currencies); a Regional index such as an Asian Index (to provide trading opportunities in and as a measure of the economic relationship of a defined geographic part of the world to the global economy); or a Theme index such as a High Yield Index (to provide trading opportunities to participate in an economic area concentration with the currency from those countries with similar attributes such as resource or high yield). These and other applicable indices may provide a broad indication of the international value of a base currency, regional set of currencies, or theme of currencies, thereby providing a risk management hedging tool and a means of direct investment in the basket of a specified number of currencies.

These indices will typically represent a geometric weighted average of foreign currencies included in an index basket. The index would be weighted to reflect the relative competitiveness of base currencies goods in foreign markets, competition within a foreign country between base currencies goods, and the goods of that country and competition within other world markets between base currencies goods and the goods of a foreign country. These measures would be a gauge of financial pressures on the base currency and are aggregated to produce a weight for each currency. The index weighting will dictate in what proportion the currencies comprising the basket of currencies are purchased by the fund.

There are a variety of formulas that can be used to calculate an index value. The following approach is consistent with industry practice. The index value will be rounded to two decimal places (0.01).

$${INDEX}_{t} = K {\prod }_{i = 1}^{N} {( {FX}_{i , t} )}^{{w}_{i}}$$

Where INDEX is the calculated value of the index on the date^{t};

FX_{i,t} is the foreign exchange rate for currencyⁱ on date^{t};

Wᵢ is the weight associated with a currencyⁱ, where the weights are determined by specified percentage of individual currencies included in the currency basket and sum to 1, i.e.,

$${\sum }_{i = 1}^{N} {w}_{i} = 1 ;$$

N is the number of currencies in the index; and

K is a multiplier that will be re-calculated every time the currency weights wᵢ change.

K will be calculated as follows:

A beginning date will be selected to determine the start of the index and a beginning value for K with an INDEX value of 100.

$${INDEX}_{t} = 100 = K {\prod }_{i = 1}^{N} {( {FX}_{i , t} )}^{{w}_{i}}$$

The formula for a change in the multiplier K is as follows:

$${K}_{t} = {K}_{t - 1} \div \frac{{\prod }_{i = 1}^{N} {( {FX}_{i , t} )}^{{w}_{i , t}}}{{\prod }_{i = 1}^{N} {( {FX}_{i , t} )}^{{w}_{i , t - 1}}}$$

The INDEX measures the currency value relative to a base of 100.00. This means a quote of ‘108.50’ means the base currency value has risen 8.50% from the beginning date.

Once the weighting of the currencies in the index has been determined, the currencies comprising the basket of currencies to be held by the fund and equitized can be purchased in the corresponding amounts. The NAV/IIV calculation for the fund proceeds as set forth above for each applicable currency, and is multiplied by the weight of the currency in the basket. The total NAV/IIV for each specific currency is summed to arise at an NAV/IIV for the entire basket, i.e., the fund.

The invention may also be embodied in a closed end fund. Such an embodiment may be preferable based on regulatory requirements. For example, currently, exemptive relief from the Securities and Exchange Commission (“SEC”) is necessary in order to offer an exchange traded fund of the type described in this application. Pending receipt of exemptive relief, a closed end fund may be offered which incorporates the following features: (i) shares will be listed and traded on an exchange; (ii) assets will be invested in short-term bank instruments denominated in one or more currencies; (iii) NAV will be calculated daily as described in this application; and (iv) interest income will be distributed monthly. According to one preferred embodiment, the organizational documents of the fund will provide that upon receipt of the exemptive relief from the SEC, the fund will convert automatically into an exchange traded fund incorporating all of the features described in this application.

Another aspect of the present invention is the utilization of a network of custodian and subcustodian banks as holders of the bank instruments representing the underlying currency holdings. According to a first preferred embodiment, the fund is managed using a decision tree to determine how best to allocate assets between multiple custodians and subcustodians to avoid holding/credit risks to individual banks. This aspect of the invention is advantageous because it diversifies the holdings of the foreign currency deposits among several entities based on the most favorable holding conditions. The core benefit is to diversify the risk using the same concept as one would use to avoid concentration risks in an asset allocation strategy.

The process comprises first defining a universe of potential custodian and sub-custodian banks for holding assets. The process further comprises assigning a risk exposure limit to those entities based on pre-selected criteria. In a preferred embodiment, the criteria include, for example: capitalization, credit rating, product offering, operational capabilities, investment yield, and current asset base exposure to each bank. The process also comprises establishing a concentration bank and diversification plan based on the pre-selected criteria. The process further comprises periodically re-evaluating the risk exposure and allocating fund assets to entities with the lowest risk factors.

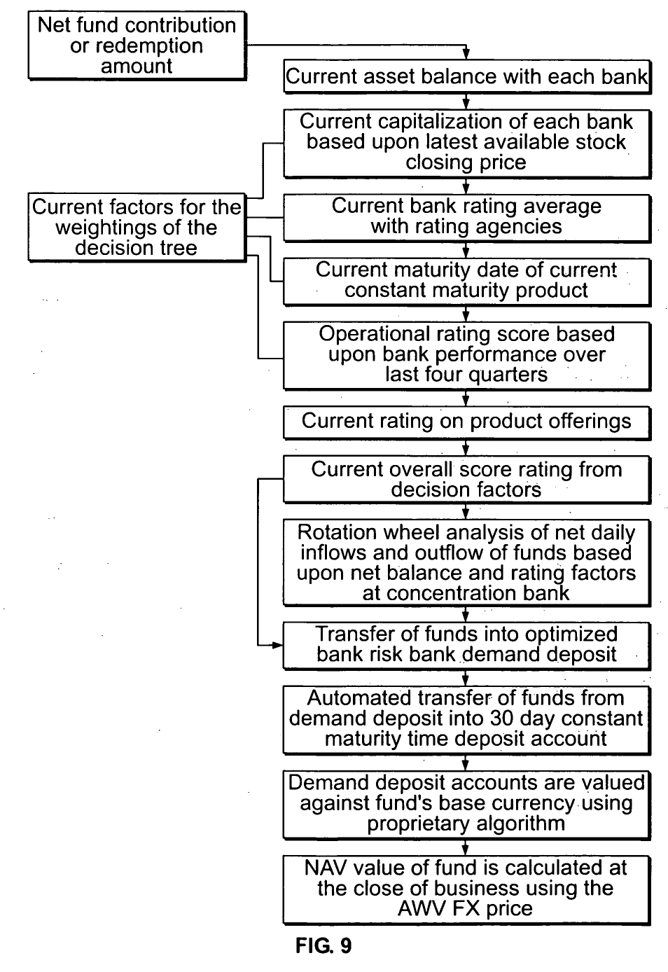

FIG. 9 depicts the general decision tree process according to embodiments of the present invention. The decision process begins with consideration of the contribution or redemption amount. The Manager/Sponsor/Trustee will then consider the current asset balance with each bank and assign preferences to the eligible banks. Next, the Manager/Sponsor/Trustee will weight: (1) the current capitalization of each bank based on, for example, the latest available stock closing price; (2) the current bank rating average with the rating agencies; (3) the current maturity date of current constant maturity products (i.e., are the appropriate short term instruments available with favorable interest rates); (4) the operational rating score based on bank performance over, for example, the last four quarters; and (5) the current rating on product offerings. The Manager/Sponsor/Trustee will attach the desired importance to each of the above factors so as to weight them appropriately, and come up with a score for each bank. From there, the Trustee/Manager/Sponsor will direct investment in the optimized bank based on the determined score as well as an analysis of net daily inflows and outflows of the fund based upon net balance and rating factors at the concentration bank. Once the currency or currencies is/are deposited, they are transferred from a demand to time deposit as described above.

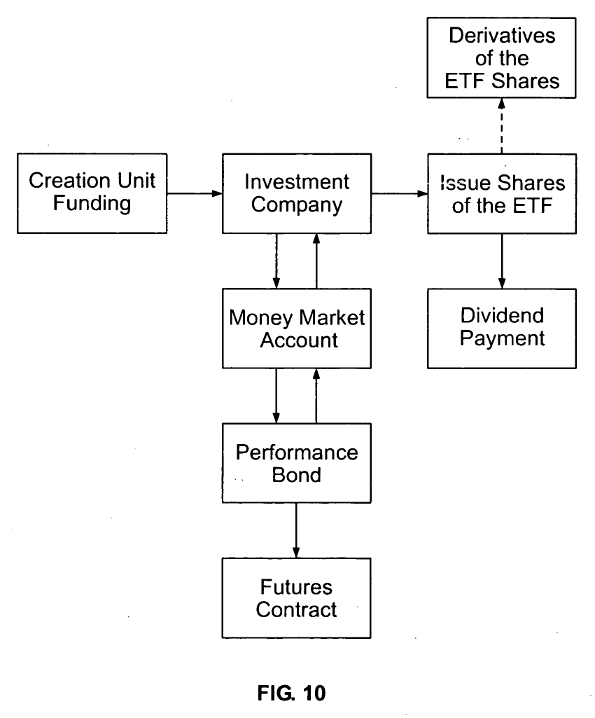

According to a preferred embodiment of the invention, the underlying assets of the fund comprise futures contracts for the target currency. Accordingly, or with reference to FIG. 10, creation unit funding of 12,500,000 euros (or other currency or commodity) is transferred to the investment company, such as a UIT organized under the Investment Company Act of 1940. The UIT (or other type of investment company structure according to other embodiments) invests the funds in a U.S. dollar diversified money market account, with interest flowing back to the investment company. The money market account invests the assets in, for example, performance bonds (such as U.S. treasury bills) which are used to invest in futures contracts. Preferably, according to one embodiment, the investment company will acquire 100 long futures contract positions per creation unit. Also preferably, the futures contracts are the nearest term contract for the target commodity. Those contracts would then be rolled prior to delivery according to the role period of the relevant exchange. The daily profit and loss cash transfer will occur between the futures contract position or the treasury bill investment.

Using this structure, the investment company (can issue creation units and dividends that have more favorable tax treatment or the profits on the futures contract investment may be taxed at a lower rate than if the assets were held in ordinary bank instruments.

The NAV according to this embodiment is calculated by taking the total U.S. dollars invested, plus or minus the value of the euro futures contracts, plus the U.S. dollars interest accrued on the money market account, divided by shares outstanding. Accordingly, the NAV will be calculated by adding the value of all investments plus cash at the end of the day. Cash will be accumulated (and subsequently reinvested or paid out if there is a redemption request made) on any given day by way of any interest payments on cash made to the account, the maturity of any money market instrument and the process of daily “marked-to-market” payments (positive or negative) from the open futures contracts.

In addition, there may, according to some embodiments, be an accounting of the daily accrued interest in the money market of the account as well as an accounting of the percent change in value of the futures contracts on a daily basis that can be attributed to the change in value of the underlying asset (for example, the euro spot price) and the “cost-of-carry” embedded into the change of price in the contract. This accounting would not be for purposes of calculating the NAV, but would be to allow investors and fund Trustees/Managers to track the efficiency of the instrument and for arbitrage. The following example will demonstrate an embodiment.

### EXAMPLE

Payment of dividends should equal the risk free rate available in the market from which the currency emanates, less fees associated with the fund. Using, for example, the LIBID of the European Common Market, and that rate was 2.5% average throughout the course of the quarter, and the funds annual fees were 0.35% and the U.S. dollar LIBID averaged 4.5% during the quarter, then the following should occur (assuming a 90 day quarter and quarterly dividend):
Each day, the fund would calculate accrued interest in the underlying U.S. dollar money market portfolio. In this case, it would represent a total of 1.125% (4.5%/360 days×90 days).
Each day, the fund would calculate accrued fees. In this case, it would represent a total of 0.0875% (0.35%/360 days×90 days).
Each day, the fund would calculate the “cost-of-carry,” which should be the difference between the U.S. dollar risk free rate (e.g., LIBID) and the euro risk free rate (e.g., LIBID) accrued daily. This would represent (4.5%/360 days×90 days)−(2.5%/360 days×90 days)=0.50%
   A preferred method of calculating the dividend payment each quarter (or whichever period is preferred by modifying the above calculation) would be to track this with a daily observation over the course of the quarter and pay the dividend accordingly on the dividend distribution date.

Another method would be to compute the same information using changes in the implied futures (forward rate) curve and take daily observations at set times to track the changes in forward discounts or premium for each day on the curve and then to divide the figure by the spot rate that day to arrive at a cost-of-carry as a percentage. This method may be more attractive to, for example, hedgers and arbitrageurs, as the forward curve is usually used by such investors to pick up inefficiencies in the currency markets.

In yet a further modification to the embodiment of FIG. 10, the investment company may employ a technical analysis to diversify the futures contracts positions based on weighting designed to achieve optimal return. The present invention contemplates any variety of criteria that may be used for such weighting. Preferably, the criteria will be set at the time of formation of the investment company, and such criteria can be mechanically applied without active management to achieve increased performance. However, other quantitative or qualitative criteria may be employed without departing from the scope of the invention.

In addition, it will be evident that the present invention can be adapted to allow the trading of derivatives (all variety of options and futures) based on the fund shares.

It will be apparent to those skilled in the art that various modifications and variations can be made in the method and system of the present invention without departing from the spirit or scope of the invention. Thus, it is intended that the present invention include modifications and variations that are within the scope of the appended claims and their equivalents.

What is claimed is:

1. An exchange traded fund comprising:
an amount of a commodity, wherein the commodity is deposited with one or more custodians in exchange for one or more creation units as assets of the fund;
wherein each creation unit represents a plurality of shares of the fund; and
wherein each creation unit is redeemable for an amount of the commodity equal to the net asset value of the creation unit; and
wherein the assets of the fund are invested in futures contracts

2. The exchange traded fund of claim 1 wherein the commodity is currency.

3. The exchange traded fund of claim 1 wherein the net asset value of each share of the fund is based on a combination of prices of the commodity from a plurality of sources.

4. The exchange traded fund of claim 3 wherein one or more of the sources is a bank.

5. The exchange traded fund of claim 3 wherein one or more of the sources is a derivatives price for the commodity.

6. The exchange traded fund of claim 5 wherein the derivatives price is a futures price.

7. The exchange traded fund of claim 2 wherein the currency is held by the one or more custodians in a bank instrument.

8. The exchange traded fund of claim 7 wherein the bank instrument is a demand deposit.

9. The exchange traded fund of claim 7 wherein the bank instrument is a time deposit.

10. The exchange traded fund of claim 9 wherein the time deposit is a thirty day constant maturity certificate.

11. The exchange traded fund of claim 10 wherein the certificate has a constant interest rate and a floating principal.

12. The exchange traded fund of claim 1 wherein the commodity is deposited by and creation units issued to an investment company.

13. The exchange traded fund of claim 12 wherein the investment company is a management investment company.

14. The exchange traded fund of claim 2 wherein the creation unit is redeemable for an amount of currency equal to the net asset value of the creation unit plus interest and less expenses.

15. The exchange traded fund of claim 14 wherein an investment company purchases the currency for the value of the currency plus a cash component.

16. The exchange trade fund of claim 15 wherein the cash component is equivalent to interest that would have accrued on the currency if the currency had been deposited at a prior date.

17. The exchange traded fund of claim 15 wherein the fund distributes interest on the currency as a dividend.

18. The exchange traded fund of claim 16 wherein the fund distributes interest on the currency plus the cash component as a dividend.

19. The exchange traded fund of claim 2 wherein the currency is held by at least one custodian bank and one or more subcustodian banks.

20. The exchange traded fund of claim 21 wherein the custodian banks and subcustodian banks are selected based on selection criteria.

21. The exchange traded fund of claim 22 wherein the selection criteria comprise one or more of the following: capitalization, credit rating, product offering, operational capabilities, investment yield, or current asset base exposure.

22. The exchange traded fund of claim 2 wherein the currency is euros.

23. The exchange traded fund of claim 1 wherein the currency is a basket of different currencies.

24. A method for converting one or more commodities tradable on a spot market and a futures market to shares of a fund tradable on a secondary market comprising:
establishing an investment company;
accumulating assets to the trust for the purchase of the one or more commodities;
purchasing an amount of the one or more commodities with the assets;
depositing the one or more commodities with one or more custodians;
creating creation units comprising a plurality of shares, wherein the creation units are redeemable for an amount of the one or more commodities based on the net asset value of the creation unit; and
issuing the creation units to investors;
wherein the assets are used to acquire a position in one or more futures contracts derived from the one or more commodities.

25. The method of claim 24 wherein the commodity is currency.

26. The method of claim 25 wherein the net asset value is based on a combination of prices of the currency from a plurality of sources.

27. The method of claim 25 wherein one or more of the sources is a bank.

28. The method of claim 24 wherein one or more of the sources is a derivatives price for the commodity.

29. The method of claim 28 wherein the derivatives price is a futures price.

30. The method of claim 25 wherein the currency is held by the one or more custodians in a bank instrument.

31. The method of claim 30 wherein the bank instrument is a demand deposit.

32. The method of claim 30 wherein the bank instrument is a time deposit.

33. The method of claim 32 wherein the time deposit is a thirty day constant maturity certificate.

34. The method of claim 33 wherein the certificate has a constant interest rate and a floating principal.

35. The method of claim 24 wherein the investment company is a unit investment trust.

36. The method of claim 24 wherein the investment company is a management investment company.

37. The method of claim 25 wherein the investment company purchases the currency for the value of the currency plus a cash component.

38. The exchange trade fund of claim 37 wherein the cash component is equivalent to interest that would have accrued on the currency if the currency had been deposited at a prior date.

39. The method of claim 24 wherein the investment company distributes gain from the futures contract position as a dividend.

40. The method of claim 37 wherein the investment company distributes interest on the currency plus the cash component as a dividend.

41. The method of claim 25 wherein the currency is held by at least one custodian bank and one or more subcustodian banks.

42. The method of claim 41 wherein the custodian banks and subcustodian banks are selected based on selection criteria.

43. The method of claim 42 wherein the selection criteria comprise one or more of the following: capitalization, credit rating, product offering, operational capabilities, investment yield, or current asset base exposure.

44. The method of claim 25 wherein the currency is euros.

45. The method of claim 25 wherein the currency is a basket of different currencies.

46. A method for facilitating the trading of an exchange traded fund comprising:
providing an exchange comprising a secondary market for shares of the fund; and
wherein the exchange traded fund comprises:
an amount of a commodity trading in a spot and futures market, wherein the commodity is deposited with one or more custodians in exchange for one or more creation units as assets of the fund;
wherein each creation unit represents a plurality of shares of the fund; and
wherein each creation unit is redeemable for an amount of the commodity equal to the net asset value of the creation unit; and
wherein the assets of the fund are invested in futures contracts.

47. The method of claim 46 wherein the commodity is currency

48. The method of claim 46 wherein the net asset value of each share of the fund is based on a combination of prices of the commodity from a plurality of sources.

49. The method of claim 46 wherein the creation unit is redeemable for an amount of the commodity equal to the net asset value of the creation unit plus interest and less fund expenses.

50. The method of claim 48 wherein one or more of the sources is a bank.

51. The method of claim 49 wherein one or more of the sources is a derivatives price for the commodity.

52. The method of claim 51 wherein the derivatives price is a futures price.

53. The method of claim 47 wherein the currency is held by the one or more custodians in a bank instrument.

54. The method of claim 53 wherein the bank instrument is a demand deposit.

55. The method of claim 53 wherein the bank instrument is a time deposit.

56. The method of claim 55 wherein the time deposit is a thirty day constant maturity certificate.

57. The method of claim 56 wherein the certificate has a constant interest rate and a floating principal.

58. The method of claim 46 wherein the commodity is deposited by and creation units issued to an investment company.

59. The method of claim 58 wherein the investment company is a unit investment trust.

60. The method of claim 58 wherein the investment company is a management investment company.

61. The method of claim 47 wherein an investment company purchases the currency for the value of the currency plus a cash component.

62. The method of claim 61 wherein the cash component is equivalent to interest that would have accrued on the currency if the currency had been deposited at a prior date.

63. The method of claim 46 wherein the fund distributes gain on the futures position as a dividend.

64. The method of claim 61 wherein the fund distributes interest on the currency plus the cash component as a dividend.

65. The method of claim 47 wherein the currency is held by at least one custodian bank and one or more subcustodian banks.

66. The method of claim 65 herein the custodian banks and subcustodian banks are selected based on selection criteria.

67. The method of claim 66 wherein the selection criteria comprise one or more of the following: capitalization, credit rating, product offering, operational capabilities, investment yield, or current asset base exposure.

68. The method of claim 47 wherein the currency is euros.

69. The method of claim 47 wherein the currency is a basket of different currencies.
